(19) United States
(12) Patent Application Publication
(10) Pub. No.: US 2024/0083761 A1
(43) Pub. Date: Mar. 14, 2024

(54) METHOD FOR MANUFACTURING HALOGENATED LITHIUM AND METHOD FOR MANUFACTURING SULFIDE SOLID ELECTROLYTE

(71) Applicant: IDEMITSU KOSAN CO.,LTD, Tokyo (JP)

(72) Inventors: Takayoshi KAMBARA, Chiba-shi, Chiba (JP); Hiroaki YAMADA, Chiba-shi, Chiba (JP)

(73) Assignee: IDEMITSU KOSAN CO.,LTD., Tokyo (JP)

(21) Appl. No.: 18/272,857

(22) PCT Filed: Jan. 17, 2022
(86) PCT No.: PCT/JP2022/001407

§ 371 Date: Jul. 18, 2023

(30) Foreign Application Priority Data
Jan. 19, 2021 (JP) 2021-006664

(51) Int. Cl. C01D 15/04; C01B 17/45; H01M 10/0562

(52) U.S. Cl. CPC C01D 15/04; C01B 17/45; H01M 10/0562; C01P 2002/50; C01P 2002/72; C01P 2006/40; H01M 2300/008

(57) ABSTRACT

The present invention relates to a method for producing a lithium halide compound, including performing a mixing heat treatment step of mixing lithium sulfide and an ammonium halide under a heating condition of 90 to 250° C., and which does not involve a step of directly removing water, does not use a simple substance halogen which is complicated to handle, can easily remove by-products, and does not require excessive energy for production.

### TECHNICAL FIELD

The present invention relates to a method for producing a lithium halide.

### BACKGROUND ART

With the rapid spread of information-related devices and communication devices such as personal computers, video cameras, and cellular phones in recent years, the development of batteries to be used as power sources thereof has been emphasized. In the past, an electrolytic solution containing a flammable organic solvent has been used in batteries used for such applications, but batteries in which the electrolytic solution is replaced with a solid electrolyte layer have been developed because the safety device can be simplified by completely solidifying the battery without using a flammable organic solvent in the battery, and the production cost and productivity are excellent.

As a solid electrolyte used for the solid electrolyte layer, a sulfide solid electrolyte has been conventionally known. For example, it is known that a glass ceramic electrolyte having high ion conductivity can be obtained by reacting lithium sulfide with phosphorus sulfide to produce sulfide glass and subjecting the sulfide glass to heat treatment (see, for example, PTL 1). In addition, along with the demand for higher ion conductivity, a production method using lithium halide as a sulfide solid electrolyte containing a halogen atom is also known (for example, see PTL 2).

Lithium halide used as a raw material for producing a sulfide solid electrolyte containing a halogen atom is generally produced as a hydrate because an aqueous raw material is used in a synthesis process or a reaction is performed in water (for example, see PTLs 3 and 4). When the lithium halide contains water, the ion conductivity of the sulfide solid electrolyte may decrease. Therefore, it is necessary to remove water from the lithium halide, and a method of removing water by azeotropy with an organic solvent and drying (for example, see PTL 4), a method of removing water by heating under reduced pressure (for example, see PTLs 5 and 6), and the like have been studied. However, in any case, it is not easy to remove water from the lithium halide hydrate.

Therefore, a method for producing an anhydrous lithium halide or the like without removing water has been studied. For example, there is disclosed a method in which lithium sulfide is reacted with a halogen molecule in a solvent such as an aromatic hydrocarbon in which an alkali metal sulfide is hardly dissolved while using a pulverizer (for example, see PTLs 7 and 8).

In addition, a method for producing an alkali metal halide by reacting an alkali metal sulfide with a simple substance halogen, and a method for producing a sulfide-based solid electrolyte using the alkali metal halide produced by the method are also disclosed (for example, see PTL 9).

### CITATION LIST

### Patent Literature

PTL 1: JP 2005-228570 A

PTL 2: JP 2013-201110 A

PTL 3: JP 2013-103851 A

PTL 4: JP 2013-256416 A

PTL 5: JP 2014-65637 A

PTL 6: JP 2014-65638 A

PTL 7: WO 2017/159665

PTL 8: WO 2017/159667

PTL 9: JP 2019-145489 A

### SUMMARY OF INVENTION

### Technical Problem

The present invention has been made in view of such circumstances, and an object thereof is to provide a method for producing a lithium halide that does not involve a step of directly removing water, does not use a simple substance halogen that is complicated to handle, can easily remove by-products, and does not require excessive energy for production.

### Solution to Problem

The method for producing a lithium halide compound according to the present invention is a method for producing a lithium halide compound characterized by performing a mixing heat treatment step of mixing lithium sulfide and an ammonium halide under a heating condition of 90 to 250° C.

Another method for producing a lithium halide compound according to the present invention is a method for producing a lithium halide including mixing lithium sulfide and an ammonium halide and heating.

### Advantageous Effects of Invention

According to the present invention, it is possible to provide a method for producing a lithium halide, which does not involve a step of directly removing water, does not use a simple substance halogen which is complicated to handle, and can easily remove by-products.

### BRIEF DESCRIPTION OF DRAWINGS

FIG. 1 is an X-ray diffraction spectrum of lithium sulfide used in Example 1 and lithium iodide obtained in Example 1.

FIG. 2 is an X-ray diffraction spectrum of the lithium halide complex and lithium iodide obtained in Example 2.

FIG. 3 is an X-ray diffraction spectrum of lithium bromide and lithium iodide obtained in Example 3.

FIG. 4 is an X-ray diffraction spectrum of the lithium iodide complex and lithium iodide obtained in Example 4.

FIG. 5 is an X-ray diffraction spectrum of the lithium iodide complex and lithium iodide obtained in Example 5.

FIG. 6 is an X-ray diffraction spectrum of the lithium iodide complex and lithium iodide obtained in Example 6.

FIG. 7 is an X-ray diffraction spectrum of the lithium iodide complex and lithium iodide obtained in Example 7.

FIG. 8 is an X-ray diffraction spectrum of the lithium iodide complex and lithium iodide obtained in Comparative Example 1.

FIG. 9 is an X-ray diffraction spectrum of the lithium iodide complex and lithium iodide obtained in Comparative Example 2.

### DESCRIPTION OF EMBODIMENTS

Hereinafter, an embodiment of the present invention (hereinafter, may be referred to as “the present embodiment”) will be described. In the description herein, the numerical values of the upper limit and the lower limit related to the numerical ranges of “X or more” and “Y or less”, and “X to Y” are numerical values that can be arbitrarily combined, and the numerical values of the Examples can also be used as the numerical values of the upper limit and the lower limit.

### (Findings Obtained by the Inventor to Arrive at the Present Invention)

As a result of intensive studies to solve the above-mentioned problems, the present inventors have found the following matters and completed the present invention.

In the methods for producing a lithium halide described in PTLs 7 and 8, handling is complicated because a simple substance halogen is used, and it is necessary to remove sulfur as a by-product in a subsequent step.

Further, PTL 9 describes a method for generating a solid electrolyte having a controlled fine particle shape by introducing a raw material of the solid electrolyte containing a lithium element, a sulfur element, and a phosphorus element into thermal plasma, evaporating the raw material, and then cooling the evaporated raw material. However, in the production method using thermal plasma, there is a problem that since the energy required for production is excessive, it is not practical on an industrial scale.

Therefore, the present inventors have intensively studied a new reaction process capable of producing a lithium halide without causing the above-mentioned problems, and have found that according to a method for producing a lithium halide by reacting lithium sulfide with an ammonium halide, since ammonia and hydrogen sulfide generated as by-products can be removed in the form of gas, it is possible to produce a lithium halide by a method in which the amount of water and the residual amount of by-products are small and the energy required for production is not excessive.

In addition, ammonia or hydrogen sulfide obtained as a by-product as described above can be recycled and reused as a raw material of lithium sulfide or an ammonium halide.

### [Method for Producing Lithium Halide Compound]

A method for producing a lithium halide according to a first aspect of the present embodiment is a method for producing a lithium halide, including performing a mixing heat treatment step of mixing lithium sulfide and an ammonium halide under a heating condition of 90 to 250° C.

According to the first aspect, since an ammonium halide is used as a raw material for supplying a halogen element, it is not necessary to use a simple substance halogen as a raw material. Further, as described above, since the by-products generated by using these raw materials are ammonia and hydrogen sulfide which are gases, removal of the by-products is extremely easy. Further, by setting the heating temperature to 90 to 250° C., there is an advantage that the production energy does not become excessive while sufficiently promoting the reaction between lithium sulfide and an ammonium halide which are raw materials.

In addition, in the first aspect, the mixing heat treatment of the lithium sulfide and the ammonium halide may be performed in the absence of a solvent, but a solvent may be positively used, or the mixing heat treatment may be performed in a state in which some solvent remains.

A method for producing a lithium halide according to a second aspect of the present embodiment is a method for producing a lithium halide, in which the mixing heat treatment step is performed under reduced pressure or under an inert gas in the method for producing a lithium halide according to the first aspect.

According to the second aspect, by performing the mixing heat treatment step under reduced pressure or under an inert gas, various impurities remaining in the lithium halide as the reaction product can be removed more efficiently.

A method for producing a lithium halide according to a third aspect of the present embodiment is the method for producing a lithium halide according to the first or second aspect, in which lithium sulfide is blended at a ratio of more than 1 mol with respect to 2 mol of ammonium halide.

By blending the ammonium halide and the lithium sulfide at the above-described molar ratio, composite particles in which at least a part of the lithium halide forms a solid solution with lithium sulfide are obtained. By reacting the composite particles with phosphorus sulfide as they are, it is possible to produce a sulfide solid electrolyte in which lithium halide is dispersed and which has higher ion conductivity.

A method for producing a lithium halide according to a fourth aspect of the present embodiment is the method for producing a lithium halide according to the third aspect, in which the lithium halide is obtained as composite particles in which at least a part of the lithium halide forms a solid solution with lithium sulfide.

In the case where the lithium halide obtained by the production method of the present embodiment is composite particles in which the lithium halide and the lithium sulfide form a solid solution, when the composite particles are used as a raw material for a sulfide solid electrolyte, the lithium halide can be supplied by subtracting the amount of lithium sulfide contained in the composite particles. Therefore, when the amount of lithium sulfide contained in the composite particles satisfies the amount required for producing a sulfide solid electrolyte, it is not necessary to newly supply lithium sulfide, and it is possible to more efficiently obtain a sulfide solid electrolyte. This can be said to be an industrially advantageous secondary effect.

A method for producing a sulfide solid electrolyte according to a fifth aspect of the present embodiment is a method for producing a sulfide solid electrolyte, including reacting a lithium halide obtained by the production method according to any one of the first to fourth aspects with a phosphorus compound.

The lithium halide obtained by the method for producing a lithium halide according to any one of the first to fourth aspects of the present embodiment described above is suitably used for producing a sulfide solid electrolyte.

A method for producing a sulfide solid electrolyte according to a sixth aspect of the present embodiment is a method for producing a sulfide solid electrolyte in which a lithium compound other than lithium halide is further reacted in the method for producing a sulfide solid electrolyte according to the fifth aspect.

The lithium compound other than the lithium halide to be reacted in the present embodiment may be prepared separately from the above-described lithium halide and phosphorus compound. On the other hand, when the lithium halide is obtained as composite particles in which the lithium halide forms a solid solution with lithium sulfide by the method for producing a lithium halide according to the third or fourth aspect, the lithium sulfide may be used as a lithium compound other than the lithium halide.

A method for producing a lithium halide according to a seventh aspect of the present embodiment is a method for producing a lithium halide, including mixing lithium sulfide and an ammonium halide and heating the mixture.

According to the seventh aspect, since the ammonium halide is used as a raw material for supplying a halogen element, it is not necessary to use a simple substance halogen as a raw material. Further, as described above, since the by-products generated by using these raw materials are ammonia and hydrogen sulfide which are gases, removal of the by-products is extremely easy.

A method for producing a sulfide solid electrolyte according to an eighth aspect of the present embodiment is a method for producing a sulfide solid electrolyte, including reacting a lithium halide obtained by the production method according to the seventh aspect with a phosphorus compound.

The lithium halide obtained by the method for producing a lithium halide according to the seventh aspect of the present embodiment described above is suitably used in the production of a sulfide solid electrolyte.

A method for producing a sulfide solid electrolyte according to a ninth aspect of the present embodiment is a method for producing a sulfide solid electrolyte in which a lithium compound other than lithium halide is further reacted in the method for producing a sulfide solid electrolyte according to the eighth aspect.

The lithium compound other than the lithium halide to be reacted in the present embodiment may be prepared separately from the above-described lithium halide and phosphorus compound. On the other hand, when the lithium halide is obtained as composite particles in which the lithium halide forms a solid solution with lithium sulfide, the lithium sulfide may be used as a lithium compound other than the lithium halide.

Hereinafter, the production method of the present embodiment will be described in more detail based on the above-described embodiment.

### [Lithium Sulfide]

The lithium sulfide used in the production method of the present embodiment is usually in the form of particles, and may be a commercially available product or a product produced by a known method.

Examples of known methods for obtaining lithium sulfide include a method in which lithium sulfide is synthesized by reacting lithium hydroxide and hydrogen sulfide at 70° C. to 300° C. in a hydrocarbon-based organic solvent to produce lithium hydrosulfide and then dehydrodesulfurizing the reactant (JP 2010/163356 A) and a method of synthesizing lithium sulfide by reacting lithium hydroxide and hydrogen sulfide at 130° C. or higher and 445° C. or lower (JP 9-278423A).

The average particle diameter (D₅₀) of the lithium sulfide used in the production method of the present embodiment is preferably 0.1 μm or more and 200 μm or less, more preferably 0.3 μm or more and 150 μm or less, and still more preferably 0.5 μm or more and 100 μm or less. In the description herein, the average particle diameter (D₅₀) is the particle diameter at which 50% of the total particle diameter is reached by sequentially integrating from the smallest particle when a particle size distribution integration curve is drawn, and the volume distribution is the average particle diameter that can be measured using, for example, a laser diffraction/scattering particle size distribution measuring apparatus.

The amount of water contained in the lithium sulfide as an impurity is preferably small from the viewpoint of reducing the amount of water in the obtained lithium halide, and further reducing the amount of water in the solid electrolyte when the lithium halide is used as a raw material of the sulfide solid electrolyte, and suppressing a decrease in ion conductivity and a decrease in battery performance due to water. The amount of water contained in the lithium sulfide is preferably 1.5% by mass or less, more preferably 1% by mass or less, and still more preferably 0.5% by mass or less. The lower limit is not particularly limited since a smaller amount is more preferable, but is usually about 0.1% by mass. In the description herein, the amount of water in lithium sulfide is a value measured under the conditions of 280° C. by a vaporization method using a Karl Fischer moisture meter.

### [Ammonium Halide]

The ammonium halide used in the production method of the present embodiment may be selected according to the desired lithium halide. It is preferable to use one or more selected from ammonium fluoride (NH₄F), ammonium chloride (NH₄Cl), ammonium bromide (NH₄Br), and ammonium iodide (NH₄I). Among these, it is more preferable to use at least one selected from ammonium bromide (NH₄Br) and ammonium iodide (NH₄I).

In the production method of the present embodiment, lithium sulfide and ammonium halide react with each other according to a reaction formula represented by the following reaction formula (1). Therefore, from the viewpoint of reacting all of the ammonium halides, the amount of lithium sulfide used is preferably not 1 mol or more with respect to 2 mol of ammonium halide, and when a plurality of kinds of ammonium halides are used, the amount of lithium sulfide used is preferably 1 mol or more with respect to a total of 2 mol of the plurality of kinds of ammonium halides.

In addition, when lithium halide is produced by setting the amount of lithium sulfide used to 5.5 to 7.5 mol with respect to a total of 2 mol of the ammonium halide, about 4.5 to 6.5 mol of lithium sulfide remains with respect to 2 mol of lithium halide. Therefore, it is preferable because lithium sulfide can be used as a material of a solid electrolyte without newly adding lithium sulfide. Similarly, the amount of lithium sulfide used to 6.6 to 7.4 mol is more preferable, and 6.7 to 7.3 mol is still more preferable, with respect to a total of 2 mol of the ammonium halide.

Li₂S+2NH₄X→2LiX+2NH₃+H₂S (1)

(In Formula (1), X is a halogen atom.)

As is clear from the above reaction formula (1), in the production method of the present embodiment, a lithium halide is produced by the reaction between lithium sulfide and an ammonium halide, and at the same time, ammonia and hydrogen sulfide are generated as by-products, but these are advantageous in that they are easily removed because they are gases.

In addition, it is possible to cope with mass production by selecting lithium sulfide and an ammonium halide which are easily available as raw materials.

### [Mixing Heat Treatment Step]

In the production method of the present embodiment, it is necessary to perform a mixing heat treatment step of mixing the lithium sulfide and the ammonium halide under a heating condition of 90 to 250° C. When the temperature of the mixing heat treatment step is lower than 90° C., the reaction between the lithium sulfide and the ammonium halide becomes insufficient, and when the temperature is higher than 250° C., heating becomes excessive, and thus excessive energy may be used to produce the lithium halide. From these viewpoints, the temperature of the mixing heat treatment step is preferably 100 to 240° C., and more preferably 120 to 220° C.

It is preferable that the mixing heat treatment step is performed in the absence of a solvent or using a solvent, and lithium sulfide and an ammonium halide are reacted with each other.

The mixing heat treatment step is preferably performed under an inert gas such as nitrogen or argon because ammonia and hydrogen sulfide as by-products can be effectively removed and the reaction can be promoted.

In the production method of the present embodiment, the generated lithium halide may form a complex with ammonia generated as a by-product, but the ammonia can be removed by performing the mixing heat treatment step.

In the production method of the present embodiment, by mixing the lithium sulfide and the ammonium halide, the lithium halide is obtained by the reaction between the lithium sulfide and the ammonium halide, and ammonia and hydrogen sulfide which are by-products are removed in the form of a gas, so that a reverse reaction hardly occurs, and the reaction is promoted.

When the lithium sulfide, the ammonium halide, and the solvent to be used as necessary are mixed, the mixing method is not particularly limited, and the lithium sulfide, the ammonium halide, and the solvent to be used as necessary may be put into an apparatus capable of mixing them, and mixed while being heated to the predetermined temperature.

When the lithium sulfide and the ammonium halide are mixed in the absence of a solvent, for example, they can be mixed by a mechanical milling method in which they are reacted using a pulverizer such as a ball mill or a bead mill.

When the lithium sulfide and the ammonium halide are mixed using a solvent, these raw materials may be charged into a large excess of the solvent and stirred, or a small amount of the solvent may be charged together with the lithium sulfide and the ammonium halide into an apparatus or a pulverizer capable of mixing the above-mentioned raw materials and then mixed.

The apparatus used for mixing the lithium sulfide and the ammonium halide, optionally with the addition of a small amount of a solvent, may be appropriately selected depending on the scale. For example, in the case of a small scale, an apparatus such as a Schlenk equipped with a stirring bar may be used, and in the case of a medium to large scale, a mechanical stirring type mixer equipped with a stirring blade in a tank may be used.

Examples of the mechanical stirring mixer include a high-speed stirring type mixer and a double-arm type mixer. From the viewpoint of enhancing the uniformity of the raw material mixture, a high-speed stirring type mixer is preferably used. Further, examples of the high-speed stirring type mixer include a vertical shaft rotation type mixer and a horizontal shaft rotation type mixer, and either type of mixer may be used.

Examples of the shape of the stirring blade used in the mechanical stirring type mixer include a blade type, an arm type, an anchor type, a paddle type, a full-zone type, a ribbon type, a multi-stage blade type, a double-arm type, an excavator type, a two shaft type, a flat blade type, and a C-type blade type. From the viewpoint of efficiently promoting the reaction between lithium sulfide and halogen molecules, rapidly dissolving the obtained lithium halide, and easily suppressing the deposition of lithium sulfide on the surface, the excavator type, the flat blade type, the C-type blade type, the anchor type, the paddle type, the full-zone type, and the like are preferred, and the anchor type, the paddle type, and the full-zone type are more preferred.

The mixing time in the mixing heat treatment step is usually about 0.1 to 500 hours, but from the viewpoint of allowing the reaction between the lithium sulfide and the ammonium halide to proceed sufficiently, the mixing time is preferably 0.5 to 100 hours, more preferably 1 to 50 hours, still more preferably 2 to 25 hours, and even more preferably 3 to 10 hours.

### [Premixing]

In the production method of the present embodiment, the lithium sulfide, the ammonium halide, and the solvent used as necessary are preferably mixed in advance before the mixing heat treatment step because the reaction in the mixing heat treatment step is promoted.

The mixing method and the solvent used for the premixing are the same as those used in the mixing heat treatment step, but the mixing time is preferably 1 to 400 hours, more preferably 5 to 300 hours, still more preferably 10 to 200 hours, and even more preferably 15 to 150 hours.

### [Solvent]

Preferred examples of the solvent used in the present embodiment include solvents containing a carbon atom, such as hydrocarbon solvents such as an aliphatic hydrocarbon solvent, an alicyclic hydrocarbon solvent, and an aromatic hydrocarbon solvent; and solvents containing a carbon atom and a hetero atom.

Examples of the aliphatic hydrocarbon solvent include hexane, pentane, 2-ethylhexane, heptane, octane, decane, undecane, dodecane, and tridecane; examples of the alicyclic hydrocarbon solvent include cyclohexane and methylcyclohexane; examples of the aromatic hydrocarbon solvent include benzene, toluene, xylene, mesitylene, ethylbenzene, tert-butylbenzene, chlorobenzene, trifluoromethylbenzene, and nitrobenzene; and examples of the solvent containing a carbon atom and a hetero atom include carbon disulfide, diethyl ether, dibutyl ether, and tetrahydrofuran.

Among these solvents, an alicyclic hydrocarbon solvent or a solvent containing a carbon atom and a hetero atom is preferable, cyclohexane is preferable among the alicyclic hydrocarbon solvents, a solvent containing an oxygen atom is preferable among the solvents containing a carbon atom and a hetero atom, and tetrahydrofuran is more preferable. Among these solvents, tetrahydrofuran is particularly preferable. It should be noted that the use of water as the solvent is not preferable because the performance of the solid electrolyte is deteriorated.

The amount of the solvent to be used is such that the total amount of the lithium sulfide and the ammonium halide used per liter of the solvent is preferably 0.1 to 1 kg, more preferably 0.05 to 0.8 kg, and still more preferably 0.2 to 0.7 kg. In a case where the amount of the solvent to be used is within the above range, the raw materials can be reacted more smoothly, and in a case where it is necessary to remove the solvent, the solvent can be easily removed.

### [Composite Particle]

In the production method of the present embodiment, by blending lithium sulfide in a ratio of more than 1 mol with respect to 2 mol of ammonium halide, it is possible to obtain a composite particle in which at least a part of the lithium halide forms a solid solution with the lithium sulfide.

In the case of a composite particle in which the generated lithium halide forms a solid solution with the lithium sulfide, a peak is detected at a position deviated from an original crystallization peak by X-ray diffraction.

### [Removal of Solvent]

When a solvent is used in the production method of the present embodiment, a lithium halide is obtained by removing the solvent. When the solvent is removed, a method such as solid-liquid separation such as filtration, decantation, and centrifugal separation may be adopted, or a method by drying may be adopted. These methods will be described later.

Filtration is a method adopted for removing the solvent present as a liquid, and may be performed using, for example, a glass filter. As the glass filter, for example, a glass filter having a pore size of about 10 to 200 μm, preferably 20 to 150 μm may be used.

In a case where decantation is performed, it can be performed by removing a solvent which becomes a supernatant after a solid is precipitated.

Centrifugal separation can be performed using a centrifuge.

Drying can be performed by drying under reduced pressure, drying by heating or the like, and for example, drying under reduced pressure and then drying by heating can be performed, or drying by heating under reduced pressure can be performed.

Drying under reduced pressure can be performed using, for example, a vacuum pump, and the drying is preferably performed under reduced pressure from the viewpoint of shortening the drying time.

When the drying is performed by heating, the drying can be performed at a temperature corresponding to the type of the solvent, and for example, can be performed at a temperature equal to or higher than the boiling point of the solvent. In this case, the heating temperature is usually from 30 to 140° C., preferably 40 to 130° C., more preferably 50 to 120° C., and still more preferably 60 to 100° C., although the heating temperature depends on the degree of pressure reduction and cannot be generally determined.

The details of the method for producing a lithium halide according to the seventh aspect of the present embodiment are the same as those of the methods for producing a lithium halide according to the first to fourth aspects described above, except that the heating condition is not limited to 90 to 250° C., and heating and mixing can be performed separately.

As described above, the lithium halide compound obtained by the production method of the present embodiment includes a lithium halide complex and a lithium halide composite particle in addition to the lithium halide. Since any of these lithium halides has a low water content and high quality even though removal of water is not performed, it is suitably used as a raw material of a sulfide solid electrolyte.

The amount of water contained in the lithium halide obtained by the production method of the present embodiment is 1% by mass or less, and further 0.5% by mass or less, or 0.3% by mass or less. The lower limit is usually about 0.01% by mass. In the description herein, the amount of water in the lithium halide compound is a value measured under the conditions of 280° C. by a vaporization method using a Karl Fischer moisture meter, similarly to the amount of water in lithium sulfide.

### <Method for Producing Sulfide Solid Electrolyte>

The lithium halide obtained by the production method of the present embodiment is suitably used as a raw material for a sulfide solid electrolyte as described above. The sulfide solid electrolyte is obtained, for example, by a production method including reacting the lithium halide obtained by the production method of the present embodiment, a lithium compound other than lithium halide, and a phosphorus compound. The production method including reacting lithium halide, a lithium compound other than lithium halide, and a phosphorus compound is a known method, and specific treatments, operations, and the like may be performed according to known methods.

In addition, the production method of the present embodiment may be a method including a step of reacting the above-mentioned composite particles in which the lithium halide and the lithium sulfide form a solid solution with a phosphorus compound.

Examples of the lithium halide include lithium fluoride, lithium chloride, lithium bromide, and lithium iodide, and lithium bromide and lithium iodide are preferable.

Preferred examples of the lithium compound other than the lithium halide include lithium sulfide (Li₂S), lithium oxide (Li₂O), and lithium carbonate (Li₂CO₃). Among them, lithium sulfide is preferable from the viewpoint of ion conductivity.

Preferred examples of the phosphorus compound include phosphorus sulfides such as diphosphorus trisulfide (P₂S₃) and diphosphorus pentasulfide (P₂S₅), and phosphate compounds such as sodium phosphate (Na₃PO₄) and lithium phosphate (Li₃PO₄). Among them, phosphorus sulfide is preferable, and diphosphorus pentasulfide (P₂S₅) is more preferable. Phosphorus compounds such as diphosphorus pentasulfide (P₂S₅) can be used without particular limitation as long as they are industrially produced and sold. These phosphorus compounds may be used alone or in combination of two or more thereof.

Further, as a compound containing a halogen atom other than lithium halide, a halogen molecule, that is, fluorine (F₂), chlorine (Cl₂), bromine (Br₂), or iodine (I2), preferably chlorine (Cl₂), bromine (Br₂), or iodine (I₂), and more preferably bromine (Br₂) or iodine (I₂) can also be used.

Among these, a combination of lithium sulfide, diphosphorus pentasulfide and a lithium halide, and a combination of lithium sulfide, diphosphorus pentasulfide, a lithium halide and a halogen molecule are preferable.

When a combination of lithium sulfide, diphosphorus pentasulfide, and a lithium halide is used as the raw material, the proportion of lithium sulfide to the total of lithium sulfide and diphosphorus pentasulfide is preferably 70 to 80 mol %, more preferably 72 to 78 mol %, and still more preferably 74 to 78 mol %, from the viewpoint of obtaining higher chemical stability and higher ion conductivity.

Further, when lithium bromide and lithium iodide are used in combination as the lithium halide, the proportion of lithium bromide to the total of lithium bromide and lithium iodide is preferably 1 to 99 mol %, more preferably 20 to 90 mol %, still more preferably 40 to 80 mol %, and particularly preferably 50 to 70 mol %, from the viewpoint of improving ion conductivity.

When lithium sulfide, diphosphorus pentasulfide, a halogen simple substance, and a lithium halide are used, the content (a mol %) of the halogen simple substance and the content (8 mol %) of the lithium halide with respect to the total amount thereof preferably satisfy the following mathematical formula (2), more preferably satisfy the following mathematical formula (3), still more preferably satisfy the following mathematical formula (4), and even more preferably satisfy the following mathematical formula (5).

2≤2α+β≤100 (2)

4≤2α+β≤80 (3)

6≤2α+β≤50 (4)

6≤2α+β≤30 (5)

In the reaction of the lithium halide, the lithium compound other than the lithium halide, and the phosphorus compound, the reaction can be performed by a treatment such as mixing, stirring, or pulverization of these raw materials. For example, in the case of performing the treatment of mixing and stirring, a mechanical stirring type mixer used in the mixing in the production method of the present embodiment may be used, and in the case of performing the treatment of pulverization, a device generally called a pulverizer such as a media type mill such as a ball mill or a bead mill may be used.

Further, when the raw materials are reacted, a complexing agent or a solvent may be further added as necessary. In this case, a slurry containing an electrolyte precursor composed of the raw material and the complexing agent, the liquid complexing agent, and the solvent is obtained. The slurry is dried to remove the liquid complexing agent and the solvent, and further heated to obtain the sulfide solid electrolyte.

The drying can be performed by any method capable of performing drying in the production method of the present embodiment, and the temperature conditions and the like when performing drying by heating are the same as the conditions of drying by heating in the production method of the present embodiment because the solvent used is the same as the solvent used in the production method of the present embodiment.

As the solvent used in the method for producing a sulfide solid electrolyte of the present embodiment described above, the same solvent as that used in the method for producing a lithium halide of the present embodiment described above is used.

### [Complexing Agent]

The complexing agent is a compound capable of forming a complex (also referred to as a “lithium halide complex”) coordinated (bonded) with a lithium atom, a sulfur atom, and a halogen atom, particularly a lithium atom, contained in the lithium sulfide or the lithium halide. The complexing agent is not particularly limited as long as it has such performance, and is preferably a compound containing in particular an atom having high affinity for a lithium atom, for example, a hetero atom such as a nitrogen atom, an oxygen atom, or a chlorine atom, and more preferably a compound having a group containing such a hetero atom.

The hetero atom is more preferably a nitrogen atom or an oxygen atom.

The group containing a nitrogen atom is preferably an amino group, an amide group, a nitro group, or a nitrile group, and more preferably an amino group.

The group containing an oxygen atom is preferably an ester group or an ether group, and more preferably an ester group.

Examples of the complexing agent having an amino group include amine compounds such as an aliphatic amine, an alicyclic amine, a heterocyclic amine, and an aromatic amine, and these may be used alone or in combination of two or more.

Typical preferred examples of the aliphatic amine include aliphatic diamine such as aliphatic primary diamines such as ethylenediamine, diaminopropane, and diaminobutane; aliphatic secondary diamines such as N,N′-dimethylethylenediamine, N,N′-diethylethylenediamine, N,N′-dimethyldiaminopropane, and N,N′-diethyldiaminopropane; and aliphatic tertiary diamines such as N,N,N′,N′-tetramethyldiaminomethane, N,N,N′,N′-tetramethylethylenediamine, N,N,N′,N′-tetraethylethylenediamine, N,N,N′,N′-tetramethyldiaminopropane, N,N,N′,N′-tetraethyldiaminopropane, N,N,N′,N′-tetramethyldiaminobutane, N,N,N′,N′-tetramethyldiaminopentane, and N,N,N′,N′-tetramethyldiaminohexane. Here, in the exemplification in the description herein, for example, in the case of diaminobutane, unless otherwise specified, in addition to isomers related to the position of an amino group such as 1,2-diaminobutane, 1,3-diaminobutane, and 1,4-diaminobutane, all isomers such as linear and branched isomers are included in butane.

The number of carbon atoms of the aliphatic amine is preferably 2 or more, more preferably 4 or more, and still more preferably 6 or more, and the upper limit thereof is preferably 10 or less, more preferably 8 or less, and still more preferably 7 or less. In addition, the number of carbon atoms of the aliphatic hydrocarbon group in the aliphatic amine is preferably 2 or more, and the upper limit thereof is preferably 6 or less, more preferably 4 or less, and still more preferably 3 or less.

Typical preferred examples of the alicyclic amine include alicyclic diamines such as alicyclic primary diamines such as cyclopropanediamine and cyclohexanediamine; alicyclic secondary diamines such as bisaminomethylcyclohexane; alicyclic tertiary diamines such as N,N,N′,N′-tetramethylcyclohexanediamine and bis(ethylmethylamino)cyclohexane; and typical preferred examples of the heterocyclic amine include heterocyclic diamines such as heterocyclic primary diamines such as isophoronediamine; heterocyclic secondary diamines such as piperazine and dipiperidylpropane; and heterocyclic tertiary diamines such as N,N-dimethylpiperazine and bismethylpiperidylpropane.

The number of carbon atoms of the alicyclic amine and the heterocyclic amine is preferably 3 or more and more preferably 4 or more, and the upper limit thereof is preferably 16 or less and more preferably 14 or less.

Further, typical preferred examples of the aromatic amine include aromatic diamine such as aromatic primary diamines such as phenykliamine, tolylenediamine, and naphthalenediamine; aromatic secondary diamines such as N-methylphenylenediamine, N,N′-dimethylphenylenediamine, N,N′-bismethylphenylphenylenediamine, N,N′-dimethylnaphthalenediamine, and N-naphthylethylenediamine; and aromatic tertiary diamines such as N,N-dimethylphenylenediamine, N,N,N′,N′-tetramethylphenylenediamine, N,N,N′,N′-tetramethyldiaminodiphenylmethane, and N,N,N′,N′-tetramethylnaphthalenediamine.

The number of carbon atoms of the aromatic amine is preferably 6 or more, more preferably 7 or more, and still more preferably 8 or more, and the upper limit thereof is preferably 16 or less, more preferably 14 or less, and still more preferably 12 or less.

The amine compound used in the present embodiment may be substituted with a substituents such as an alkyl group, an alkenyl group, an alkoxyl group, a hydroxy group, or a cyano group, or with a halogen atom.

Although diamine is exemplified as a specific example, the amine compound that can be used in the present embodiment is not limited to diamine, and for example, aliphatic monoamines corresponding to various diamines such as trimethylamine, triethylamine, ethyldimethylamine, and the aforementioned aliphatic diamine; piperidine compounds such as piperidine, methylpiperidine, and tetramethylpiperidine; pyridine compounds such as pyridine and picoline; morpholine compounds such as morpholine, methylmorpholine, and thiomorpholine; imidazole compounds such as imidazole and methylimidazole; alicyclic monoamines such as monoamines corresponding to the aforementioned alicyclic diamines; heterocyclic monoamines corresponding to the aforementioned heterocyclic diamines; monoamines such as aromatic monoamines corresponding to the aforementioned aromatic diamines; as well as polyamines having three or more amino groups such as diethylenetriamine, N,N′,N″-trimethykliethylenetriamine, N,N,N′,N″,N″-pentamethykliethylenetriamine, triethylenetetramine, N,N′-bis[(dimethylamino)ethyl]-N,N′-dimethylethylenediamine, hexamethylenetetramine, and tetraethylenepentamine can be used.

Among these, a tertiary amine having a tertiary amino group as an amino group is preferable, a tertiary diamine having two tertiary amino groups is more preferable, a tertiary diamine having two tertiary amino groups at both terminals is still more preferable, and an aliphatic tertiary diamine having a tertiary amino group at both terminals is still more preferable. In the amine compound, as the aliphatic tertiary diamine having a tertiary amino group at both terminals, tetramethylethylenediamine, tetraethylethylenediamine, tetramethyldiaminopropane, and tetraethykliaminopropane are preferable, and in consideration of availability and the like, tetramethylethylenediamine (also referred to as “TMEDA”) and tetramethykliaminopropane (also referred to as “TMPDA”) are preferable.

In addition, although not particularly exemplified, a compound containing a nitrogen atom as a hetero atom and having a group other than an amino group, for example, a group such as an amido group, a nitro group, or a nitrile group can also obtain the same effects as those of a compound containing an amino group.

Examples of the complexing agent having an ether group include ether compounds such as an aliphatic ether, an alicyclic ether, a heterocyclic ether, and an aromatic ether, and these may be used alone or in combination of two or more thereof.

Examples of the aliphatic ether include monoethers such as dimethyl ether, diethyl ether, diisopropyl ether, dibutyl ether, and tert-butyl methyl ether; diethers such as dimethoxymethane, dimethoxyethane, diethoxymethane, and diethoxyethane; polyethers having three or more ether groups such as diethylene glycol dimethyl ether (diglyme) and triethylene oxide glycol dimethyl ether (triglyme); and ethers containing a hydroxy group such as diethylene glycol and triethylene glycol.

The number of carbon atoms of the aliphatic ether is preferably 2 or more, more preferably 3 or more, and still more preferably 4 or more, and the upper limit thereof is preferably 10 or less, more preferably 8 or less, and still more preferably 6 or less.

In addition, the number of carbon atoms of the aliphatic hydrocarbon group in the aliphatic ether is preferably 1 or more, and the upper limit thereof is preferably 6 or less, more preferably 4 or less, and still more preferably 3 or less.

Examples of the alicyclic ether include ethylene oxide, propylene oxide, tetrahydrofuran, tetrahydropyran, dimethoxytetrahydrofuran, cyclopentyl methyl ether, dioxane, and dioxolane, and further, examples of the heterocyclic ether include furan, benzofuran, benzopyran, dioxene, dioxine, morpholine, methoxyindole, and hydroxymethyldimethoxypyridine.

The number of carbon atoms of the alicyclic ether and the heterocyclic ether is preferably 3 or more and more preferably 4 or more, and the upper limit thereof is preferably 16 or less and more preferably 14 or less.

Further, examples of the aromatic ether include methyl phenyl ether (anisole), ethyl phenyl ether, dibenzyl ether, diphenyl ether, benzyl phenyl ether, and naphthyl ether.

The number of carbon atoms of the aromatic ether is preferably 7 or more, and more preferably 8 or more, and the upper limit thereof is preferably 16 or less, more preferably 14 or less, and still more preferably 12 or less.

The ether compound used in the present embodiment may be substituted with a substituent such as an alkyl group, an alkenyl group, an alkoxyl group, a hydroxy group, or a cyano group, or with a halogen atom.

The ether compound used in the present embodiment is preferably an aliphatic ether, and more preferably dimethoxyethane or tetrahydrofuran.

Examples of the complexing agent having an ester group include ester compounds such as an aliphatic ester, an alicyclic ester, a heterocyclic ester, and an aromatic ester, and these can be used alone or in combination of two or more thereof.

Examples of the aliphatic ester include formate esters such as methyl formate, ethyl formate, and triethyl formate; acetate esters such as methyl acetate, ethyl acetate, propyl acetate, isopropyl acetate, butyl acetate, and isobutyl acetate; propionate esters such as methyl propionate, ethyl propionate, propyl propionate, and butyl propionate; oxalate esters such as dimethyl oxalate and diethyl oxalate; malonate esters such as dimethyl malonate and diethyl malonate; and succinate esters such as dimethyl succinate and diethyl succinate.

The number of carbon atoms of the aliphatic ester is preferably 2 or more, more preferably 3 or more, and still more preferably 4 or more, and the upper limit thereof is preferably 10 or less, more preferably 8 or less, and still more preferably 7 or less. In addition, the number of carbon atoms of the aliphatic hydrocarbon group in the aliphatic ester is preferably 1 or more and more preferably 2 or more, and the upper limit thereof is preferably 6 or less, more preferably 4 or less, and still more preferably 3 or less.

Examples of the alicyclic ester include methyl cyclohexanecarboxylate, ethyl cyclohexanecarboxylate, dimethyl cyclohexanedicarboxylate, dibutyl cyclohexanedicarboxylate, and dibutyl cyclohexenedicarboxylate, and further, examples of the heterocyclic ester include methyl pyridinecarboxylate, ethyl pyridinecarboxylate, propyl pyridinecarboxylate, methyl pyrimidinecarboxylate, ethyl pyrimidinecarboxylate, and lactones such as acetolactone, propiolactone, butyrolactone, and valerolactone.

The number of carbon atoms of the alicyclic ester and the heterocyclic ester is preferably 3 or more, and more preferably 4 or more, and the upper limit thereof is preferably 16 or less and more preferably 14 or less.

Examples of the aromatic ester include benzoic acid esters such as methyl benzoate, ethyl benzoate, propyl benzoate, and butyl benzoate; phthalic acid esters such as dimethyl phthalate, diethyl phthalate, dibutyl phthalate, butyl benzyl phthalate, and dicyclohexyl phthalate; and trimellitic acid esters such as trimethyl trimellitate, triethyl trimellitate, tripropyl trimellitate, tributyl trimellitate, and trioctyl trimellitate.

The number of carbon atoms of the aromatic ester is preferably 8 or more, and more preferably 9 or more, and the upper limit thereof is preferably 16 or less, more preferably 14 or less, and still more preferably 12 or less.

The ester compound used in the present embodiment may be substituted with a substituent such as an alkyl group, an alkenyl group, an alkoxyl group, a hydroxy group, or a cyano group, or with a halogen element.

The ester compound used in the present embodiment is preferably an aliphatic ester, more preferably an acetic acid ester, and particularly preferably ethyl acetate.

In the production method of the present embodiment, the amount of the complexing agent to be used is preferably 100 mL or more, more preferably 200 mL or more, still more preferably 250 mL or more, and even more preferably 300 mL or more, and the upper limit thereof is preferably 30000 mL or less, more preferably 25000 mL or less, still more preferably 20000 mL or less, and even more preferably 10000 mL or less with respect to 1 kg of the total amount of the lithium sulfide and the lithium halide.

The sulfide solid electrolyte obtained by the production method of the present invention contains a lithium element, a sulfur element, a phosphorus element, and a halogen element, and is basically an amorphous sulfide solid electrolyte. In the description herein, the amorphous sulfide solid electrolyte is a solid electrolyte having a halo pattern in which peaks other than peaks derived from a material are substantially not observed in an X-ray diffraction pattern in X-ray diffraction measurement, and the presence or absence of a peak derived from a raw material of the solid electrolyte does not matter.

Typical examples of the amorphous sulfide solid electrolytes obtained by using the lithium halide compound obtained by the production method of the present embodiment include solid electrolytes composed of lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅-LI-LiBr; and solid electrolytes further containing other elements such as an oxygen element and a silicon element, such as Li₂S—P₂S₅—Li₂O—LiI and Li₂S—SiS₂—P₂S₅—LiI. From the viewpoint of obtaining higher ion conductivity, solid electrolytes composed of lithium sulfide, phosphorus sulfide, and lithium halide, such as Li₂S—P₂S₅—LiI, Li₂S—P₂S₅—LiCl, Li₂S—P₂S₅—LiBr, and Li₂S—P₂S₅—LiI—LiBr, are preferable.

The types of elements constituting the amorphous solid electrolyte can be confirmed by, for example, an ICP emission spectrophotometer.

The amorphous sulfide solid electrolyte can be converted into a crystalline sulfide solid electrolyte by further heating. In the description herein, the crystalline solid electrolyte is a solid electrolyte in which a peak derived from the solid electrolyte is observed in an X-ray diffraction pattern in X-ray diffraction measurement, regardless of the presence or absence of a peak derived from a raw material of the solid electrolyte. That is, the crystalline solid electrolyte contains a crystal structure derived from the solid electrolyte, and a part thereof may be a crystal structure derived from the solid electrolyte, or the whole thereof may be a crystal structure derived from the solid electrolyte. As long as the crystalline solid electrolyte has the above-described X-ray diffraction pattern, part of the crystalline solid electrolyte may contain an amorphous solid electrolyte. Therefore, the crystalline solid electrolyte includes so-called glass ceramics obtained by heating an amorphous solid electrolyte to a crystallization temperature or higher.

The heating temperature can be appropriately selected depending on the structure of the amorphous sulfide solid electrolytes and cannot be generally defined, but may be, for example, in the range of preferably 5° C. or higher, more preferably 10° C. or higher, and still more preferably 20° C. or higher, with the temperature of the peak top of the exothermic peak observed on the lowest temperature side as a starting point when a differential thermal analysis (DTA) is performed using a differential thermal analyzer (DTA device) under a temperature raising condition of 10° C./min, and the upper limit is not particularly limited, but may be about 40° C. or lower. To be specific, the heating temperature is usually preferably 130° C. or higher, more preferably 135° C. or higher, and still more preferably 140° C. or higher, and the upper limit thereof is not particularly limited, but is preferably 300° C. or lower, more preferably 280° C. or lower, and still more preferably 250° C. or lower.

The heating time is not particularly limited as long as a desired crystalline sulfide solid electrolyte is obtained, but is preferably 1 minute or more, more preferably 10 minutes or more, still more preferably 30 minutes or more, and even more preferably 1 hour or more. The upper limit of the heating time is not particularly limited, but is preferably 24 hours or less, more preferably 10 hours or less, still more preferably 5 hours or less, and even more preferably 3 hours or less.

Further, the heating is preferably performed in an inert gas atmosphere (for example, a nitrogen atmosphere or an argon atmosphere) or a reduced pressure atmosphere (in particular, a vacuum). This is because deterioration (for example, oxidation) of the crystalline solid electrolyte can be prevented. The heating method is not particularly limited, and examples thereof include a method using a hot plate, a vacuum heating apparatus, an argon gas atmosphere furnace, and a firing furnace. In addition, industrially, a horizontal dryer having a heating means and a feed mechanism, a horizontal vibration flow dryer, or the like can be used, and may be selected according to the amount of treatment to be heated.

Examples of the crystalline sulfide solid electrolytes obtained by using the lithium halide compound obtained by the production method of the present embodiment include sulfide solid electrolytes having a crystalline structure such as a Li₃PS₄ crystalline structure, a Li₄P₂S₆ crystalline structure, a Li₇PS₆ crystalline structure, a Li₇P₃S₁₁ crystalline structure, and a crystalline structure having peaks in the vicinity of 2θ=20.2° and in the vicinity of 2θ=23.6° (for example, JP 2013-16423 A).

In addition, sulfide solid electrolytes having a crystal structure such as a Li₄₋ₓGe₁₋ₓPₓS₄ thio-LISICON Region II type crystal structure (see Kanno et al., Journal of The Electrochemical Society, 148 (7) A742-746 (2001)), a crystal structure similar to a Li₄₋ₓGe₁₋ₓPₓS₄ thio-LISICON Region II type crystal structure (see Solid State Ionics, 177 (2006), 2721-2725), and the like can also be mentioned. From the viewpoint of ion conductivity, it is preferable that the crystal structure is a thio-LISICON Region II type crystal structure. Here, the “thio-LISICON Region II type crystal structure” indicates any one of a Li₄₋ₓGe₁₋ₓPₓS₄ thio-LISICON Region II type crystal structure and a crystal structure similar to a Li₄₋ₓGe₁₋ₓPₓS₄ thio-LISICON Region II type crystal structure.

Since the sulfide solid electrolyte thus obtained is obtained by using a lithium halide compound containing no water as a raw material, the sulfide solid electrolyte has low water content, high ion conductivity, and excellent battery performance. Therefore, the sulfide solid electrolyte obtained using the lithium halide compound obtained by the production method of the present embodiment can be used for any application requiring Li ion conductivity, and is particularly suitably used for a battery. The sulfide solid electrolyte may be used in the positive electrode layer, may be used in the negative electrode layer, or may be used in the electrolyte layer. Each layer can be produced by a known method.

In addition to the positive electrode layer, the electrolyte layer and the negative electrode layer, it is preferable to use a current collector as the above battery, and a known current collector can be used. For example, a layer in which a substance that reacts with the sulfide solid electrolyte, such as Au, Pt, Al, Ti, or Cu, is coated with Au or the like can be used.

### EXAMPLES

Next, the present invention will be specifically described by Examples, but the present invention is not limited by these Examples at all.

### Production Example: Production of Lithium Sulfide (Li₂S)

As a water-insoluble medium, toluene (manufactured by SUMITOMO CORPORATION) was dehydrated and measured by a Karl Fischer moisture meter to obtain a water content of 100 ppm. Then, 303.8 kg of the dehydrated toluene was added to a 500 L stainless steel reactor under a nitrogen gas stream, followed by 33.8 kg of anhydrous lithium hydroxide (manufactured by The Honjo Chemical Corporation), and the mixture was maintained at 95° C. while stirring with a twin-star stirring blade at 131 rpm.

The temperature was raised to 104° C. while blowing hydrogen sulfide (manufactured by Sumitomo Seika Chemicals Co., Ltd.) into the slurry at a feed rate of 100 L/min. An azeotropic gas of water and toluene was continuously discharged from the reactor. This azeotropic gas was dehydrated by condensing it with a condenser outside the system. During this time, the same amount of toluene as the distilled toluene was continuously supplied to keep the level of the reaction solution constant.

The water content in the condensate gradually decreased, and distillation of water was no longer observed 24 hours after the introduction of hydrogen sulfide. During the reaction, solids were dispersed in toluene and stirred, and there was no water separated from toluene.

After this, hydrogen sulfide was switched to nitrogen and flowed at 100 L/min for 1 hour. The obtained lithium sulfide (Li 2 S) was pulverized by a pin mill (100UPZ manufactured by HOSOKAWA MICRON CORPORATION) having a quantitative feeder under a nitrogen atmosphere. The charging speed was 80 g/min, and the rotational speed of the disk was 18000 rpm.

### Example 1

0.14 g (3.0 mmol) of lithium sulfide (Li₂S) and 0.87 g (6.0 mmol) of ammonium iodide were introduced into a Schlenk (capacity: 100 mL) with a stirring bar under a nitrogen atmosphere. 10 mL of tetrahydrofuran was added as a solvent, and the stirring bar was rotated to mix in the solvent for 1 hour. After it was visually confirmed that there was no coloring due to iodine in the supernatant, tetrahydrofuran used as a solvent was removed under vacuum. Next, mixing with a stirring bar was continued for 2 hours while heating to 150° C. under vacuum, and a white powder was obtained.

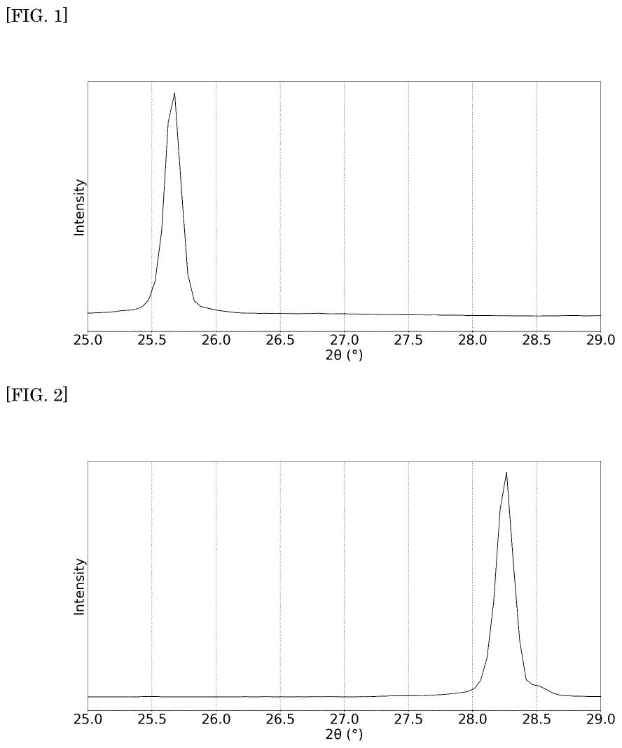

The obtained powder was subjected to powder X-ray diffraction (XRD) measurement by the following method. The lithium sulfide used as a raw material was also subjected to XRD measurement by the same method as above. The results of these XRD measurements are shown in FIG. 1. As shown in FIG. 1, it was confirmed that the obtained powder was a powder of lithium iodide because the peak of lithium sulfide disappeared and the powder had a peak attributed to lithium iodide.

In the description herein, powder X-ray diffraction (XRD) measurement was performed as follows.

Each of the powders obtained in Examples and Comparative Examples was filled in a groove having a diameter of 20 mm and a depth of 0.2 mm and leveled with glass to obtain a sample. The sample was sealed with a Kapton film for XRD and measured under the following conditions without being exposed to air.
Measuring apparatus: D2 PHASER, manufactured by Bruker
Tube voltage: 30 kV
Tube current: 10 mA
X-ray wavelength: Cu-Kα ray (1.5418 Å)
Optical system: Concentration method
Slit configuration: Solar slit 4°, divergence slit 1 mm, Kβ filter (Ni plate) used
Detector: Semiconductor detector
Measurement range: 2θ=10 to 60 deg
Step width, scan speed: 0.05 deg, 0.05 deg/sec

### Example 2

0.28 g (6.0 mmol) of lithium sulfide (Li₂S) and 1.18 g (12.0 mmol) of ammonium bromide were introduced into a Schlenk (capacity: 100 mL) with a stirring bar under a nitrogen atmosphere. As a solvent, 40 mL of tetrahydrofuran was added in a stepwise manner, and the mixture was stirred for 1 hour in the solvent by rotating the stirring bar. As a result, a green slurry was obtained. After further stirring for 24 hours, the tetrahydrofuran used as a solvent was removed under vacuum, and the solid content decreased as the concentration proceeded, and finally a yellow homogeneous solution was obtained. Next, vacuum drying was performed to obtain a white powder. Further, mixing with the stirring bar was continued for 2 hours while heating to 150° C. under vacuum.

The obtained powder was subjected to powder X-ray diffraction (XRD) measurement by the same method as in Example 1. The results of the XRD measurement of the powder are shown in FIG. 2. As shown in FIG. 2, it was confirmed that the obtained powder was a powder of lithium bromide because the peak of lithium sulfide disappeared and the powder had a peak attributed to lithium bromide.

### Example 3

0.684 g (15.0 mmol) of lithium sulfide (Li 2 S), 0.31 g (2.1 mmol) of ammonium iodide, and 0.21 g (2.1 mmol) of ammonium bromide were introduced into a Schlenk (capacity: 100 mL) with a stirring bar under a nitrogen atmosphere. 10 mL of tetrahydrofuran was added as a solvent, and the stirring bar was rotated to mix in the solvent for 1 hour. Then, tetrahydrofuran used as a solvent was removed under vacuum. Next, mixing with a stirring bar was continued for 2 hours while heating to 150° C. under vacuum, and a white powder was obtained.

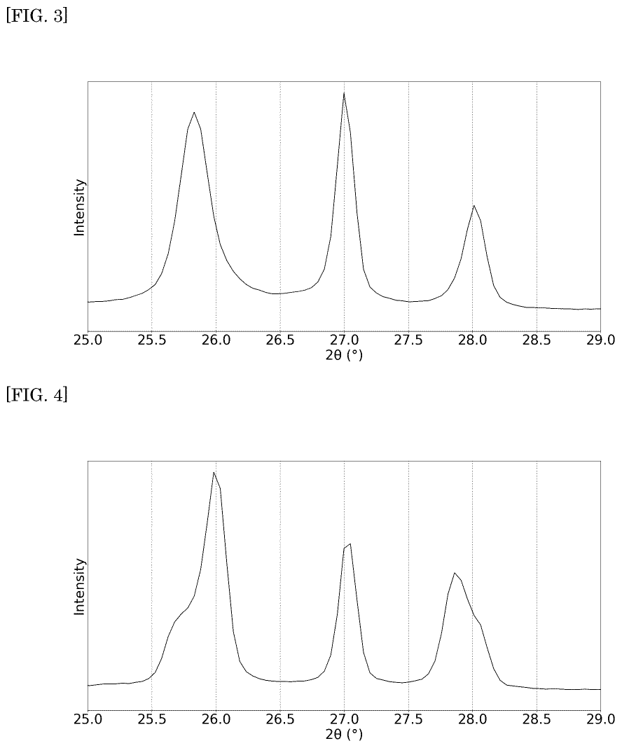

The obtained powder was subjected to powder X-ray diffraction (XRD) measurement by the same method as in Example 1. The results of the XRD measurement of the powder are shown in FIG. 3. As shown in FIG. 3, the obtained powder had a peak of lithium sulfide and a peak indicating that the lithium halide and lithium sulfide formed a solid solution.

### Example 4

0.684 g (15.0 mmol) of lithium sulfide (Li 2 S), 0.31 g (2.1 mmol) of ammonium iodide, and 0.21 g (2.1 mmol) of ammonium bromide were introduced into a reactor container under a nitrogen atmosphere. 50 mL of cyclohexane was added as a solvent and the mixture was refluxed at 115° C. for 2 hours. Thereafter, when vacuum drying was performed at room temperature, since cyclohexane was frozen, the temperature was increased to 80° C., and freeze-drying was performed. Next, mixing with a stirring bar was continued for 2 hours while heating to 200° C. under vacuum, and a white powder was obtained.

The obtained powder was subjected to powder X-ray diffraction (XRD) measurement by the same method as in Example 1. The results of the XRD measurement of the powder are shown in FIG. 4. As shown in FIG. 4, the obtained powder had a peak of lithium sulfide and a peak indicating that the lithium halide and lithium sulfide formed a solid solution.

### Example 5

0.684 g (15.0 mmol) of lithium sulfide (Li 2 S), 0.31 g (2.1 mmol) of ammonium iodide, and 0.21 g (2.1 mmol) of ammonium bromide were introduced into a reactor container under a nitrogen atmosphere. 50 mL of cyclohexane was added as a solvent, and a stirring bar was rotated to mix in the solvent for 1 hour. After that, vacuum drying was performed, and since cyclohexane was frozen, freeze-drying was performed while the temperature was increased to 150° C. in a stepwise manner. Next, mixing with a stirring bar was continued for 2 hours while heating to 200° C. under vacuum, and a white powder was obtained.

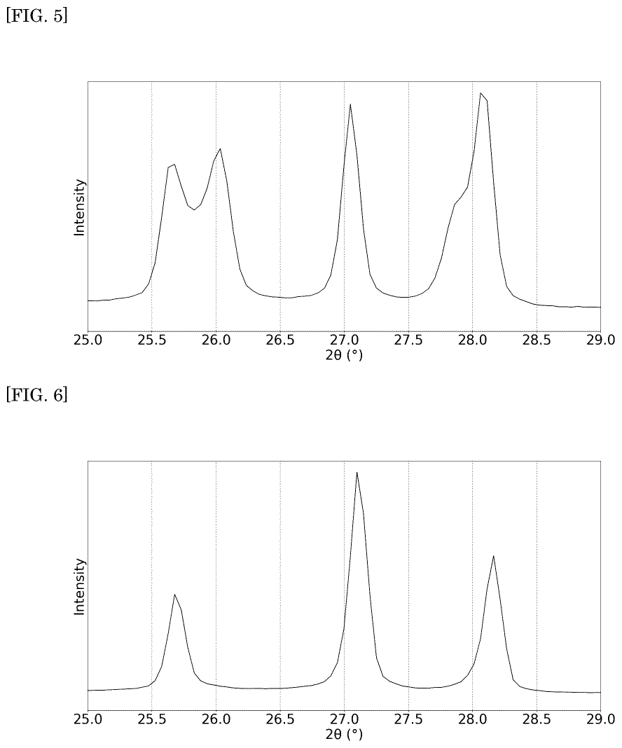

The obtained powder was subjected to powder X-ray diffraction (XRD) measurement by the same method as in Example 1. The results of the XRD measurement of the powder are shown in FIG. 5. As shown in FIG. 5, the obtained powder had a peak of lithium sulfide, a peak of the lithium halide, and a peak indicating that the lithium halide and lithium sulfide formed a solid solution.

### Example 6

In a mortar, 0.684 g (15.0 mmol) of lithium sulfide (Li 2 S), 0.31 g (2.1 mmol) of ammonium iodide, and 0.21 g (2.1 mmol) of ammonium bromide were weighed and mixed. Next, mixing with a stirring bar was continued for 2 hours while heating to 200° C. under vacuum, and a white powder was obtained.

The obtained powder was subjected to powder X-ray diffraction (XRD) measurement by the same method as in Example 1. The results of the XRD measurement of the powder are shown in FIG. 6. As shown in FIG. 6, the obtained powder had a peak of lithium sulfide and a peak of the lithium halide.

### Example 7

In a mortar, 3.42 g (72.8 mmol) of lithium sulfide (Li₂S), 1.54 g (10.6 mmol) of ammonium iodide, and 1.04 g (10.6 mmol) of ammonium bromide were weighed and mixed. Next, mixing with a stirring bar was continued for 2 hours while heating to 200° C. under nitrogen gas, and a white powder was obtained.

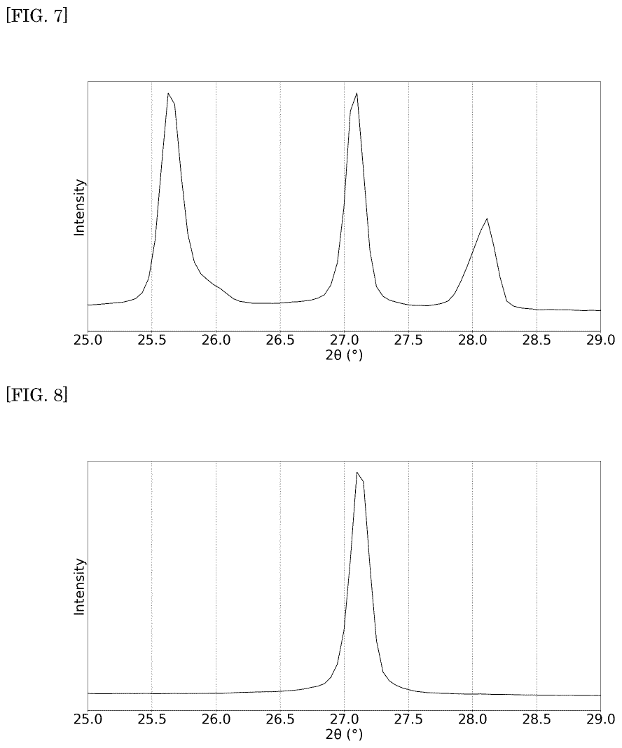

The obtained powder was subjected to powder X-ray diffraction (XRD) measurement by the same method as in Example 1. The results of the XRD measurement of the powder are shown in FIG. 7. As shown in FIG. 7, the obtained powder had a peak of lithium sulfide and a peak indicating that the lithium halide and lithium sulfide formed a solid solution.

1.06 g of the white powder and 0.945 g of diphosphorus pentasulfide were added to a Schlenk (capacity: 100 mL) with a stirring bar under a nitrogen atmosphere, 20 mL of cyclohexane and 4.5 mL of tetramethyldiamine were further added, and the stirring bar was rotated, and the mixture was stirred at room temperature for 3 days. Next, after drying under vacuum at room temperature, heating was performed at 110° C. for 2 hours to obtain an amorphous solid electrolyte. Thereafter, heating was further performed at 180° C. for 2 hours, thereby obtaining a crystalline solid electrolyte.

The ion conductivity of the obtained crystalline solid electrolyte was measured by the method described later and found to be 3.2 S/cm.

A circular pellet having a diameter of 10 mm (cross-sectional area S: 0.785 cm 2) and a height (L) of 0.1 to 0.3 cm was molded from the obtained crystalline solid electrolyte to obtain a sample. Electrical terminals were taken from the top and bottom of the sample, and measurement was performed by an alternating current impedance method at 25° C. (range of frequencies: 5 MHz to 0.5 Hz, amplitudes: 10 mV) to obtain a Cole-Cole plot. The real part Z′ (Ω) at a point where −Z″ (Ω) is minimum near the right end of the arc observed in the high-frequency side region was set as the bulk resistance R (Ω) of the electrolyte, and the ion conductivity σ (S/cm) was calculated according to the following equation.

R=ρ(L/S)

σ=1/ρ

### Comparative Example 1

In a mortar, 0.684 g (15.0 mmol) of lithium sulfide (Li₂S), 0.31 g (2.1 mmol) of ammonium iodide, and 0.21 g (2.1 mmol) of ammonium bromide were weighed and mixed.

The obtained powder was subjected to powder X-ray diffraction (XRD) measurement by the same method as in Example 1. The results of the XRD measurement of the powder are shown in FIG. 8. As shown in FIG. 8, the obtained powder had a peak of lithium sulfide, but a peak of the lithium halide was not observed.

### Comparative Example 2

The powder obtained in Comparative Example 1 was mixed with a stirring bar at room temperature under vacuum for 2 hours.

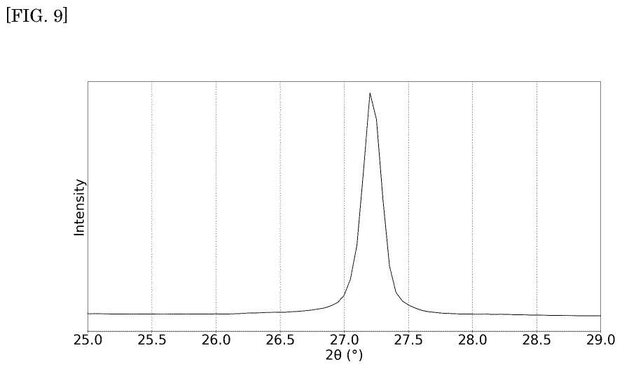

The obtained powder was subjected to powder X-ray diffraction (XRD) measurement by the same method as in Example 1. The results of the XRD measurement of the powder are shown in FIG. 9. As shown in FIG. 9, the obtained powder had a peak of lithium sulfide, but a peak of the lithium halide was not observed.

### INDUSTRIAL APPLICABILITY

According to the production method of the present invention, a step of directly removing water is not involved, a simple substance halogen which is complicated in handling is not used, and by-products can be easily removed. Since the obtained lithium halide compound has a small amount of water and a small amount of residual by-products, it can be suitably used as a raw material for a sulfide solid electrolyte.

1: A method for producing a lithium halide, comprising performing a mixing heat treatment step of mixing lithium sulfide and an ammonium halide under a heating condition of 90 to 250° C.

2: The method for producing a lithium halide according to claim 1, wherein the mixing heat treatment step is performed under reduced pressure or under an inert gas.

3: The method for producing a lithium halide according to claim 1, wherein lithium sulfide is blended at a ratio of more than 1 mol with respect to 2 mol of ammonium halide.

4: The method for producing a lithium halide according to claim 3, wherein the lithium halide is obtained as composite particles in which at least a part of the lithium halide forms a solid solution with lithium sulfide.

5: A method for producing a sulfide solid electrolyte, comprising reacting a lithium halide obtained by the method according to claim 1 with a phosphorus compound.

6: The method for producing a sulfide solid electrolyte according to claim 5, further comprising reacting with a lithium compound other than lithium halide.

7: A method for producing a lithium halide, comprising mixing lithium sulfide and an ammonium halide and heating the mixture.

8: A method for producing a sulfide solid electrolyte, comprising reacting a lithium halide obtained by the method according to claim 7 with a phosphorus compound.

9: The method for producing a sulfide solid electrolyte according to claim 8, further comprising reacting with a lithium compound other than lithium halide.
